(19) United States
(12) Patent Application Publication
(10) Pub. No.: US 2009/0241138 A1
(43) Pub. Date: Sep. 24, 2009

(54) OPTICAL DISC DRIVE

(75) Inventors: Chi-Hwa Ho, Taipei (TW); Shih-Hao Yeh, Taipei (TW); Hung-Wen Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 11/623,321

(22) Filed: Jan. 16, 2007

(30) Foreign Application Priority Data
Jan. 17, 2006 (CN) 200610001420.7

(51) Int. Cl. G11B 33/02; G11B 17/03

(52) U.S. Cl. 720/601; 720/600; G9B/33.002; G9B/17.009

(57) ABSTRACT

An optical disc drive including a housing, a fixing part, a flexible flat cable and an electronic component is provided. The fixing part is disposed in the housing. The flexible flat cable is disposed in the housing and includes a first and a second portions. The first portion has a component-disposed region whose backside is in contact with the fixing part. The second portion has a conductive surface, and the second portion is connected with and opposite to the first portion. The component-disposed region is located between the fixing part and the conductive surface. Additionally, the first optical disc drive is disposed on the component-disposed region.

### CROSS-REFERENCE TO RELATED APPLICATION

This application claims the priority benefit of China application serial no. 200610001420.7, filed on Jan. 17, 2006. All disclosure of the China application is incorporated herein by reference.

### BACKGROUND OF THE INVENTION

1. Field of Invention

The present invention relates to an optical disc drive. More particularly, the present invention relates to an optical disc drive capable of electrostatic discharge protection.

2. Description of Related Art

Electrostatic is ubiquitous in nature, and it forms due to friction. For example, two insulated surfaces rub each other and may cause electrostatic discharge (ESD) after they are separated; or, ESD may incur when human body is in contact with objects. However, ESD may impact or damage the sensitive electronic components. Particularly, in recent years, because the requirement of the precision of electronic components becomes higher and higher, even small amount of ESD may cause serious damage to the electronic components. Therefore, in the electronic industry, the requirement of the capability of the ESD protection for the electronic devices is very important. The following will take the optical disc drive as an example for demonstration.

FIG. 1 is a perspective diagram of a conventional optical disc drive, wherein part of the housing is not shown. The conventional optical disc drive 100 includes a housing 110, a flexible flat cable 120, a button 130, an indicator light emitting diode (LED) 140, a circuit board 150, an optical disc tray 160, and a panel 180. The flexible flat cable 120 is connected with the circuit board 150, and the flexible flat cable 120 and the circuit board 150 are disposed in the housing 110, respectively. The optical disc tray 160 is also disposed in the housing 110, and the switch 130a within the button 130 and the indicator LED 140 are disposed upon the flexible flat cable 120 (as shown in the enlarged area) and at one side surface of the optical disc tray 160. Moreover, the panel 180 is also disposed at one side surface of the optical disc tray 160 and exposes the button 130 and the indicator LED 140.

For the conventional optical disc drive 100, when ESD occurs, the electrostatic may not only damage the switch 130a within the button 130 and the indicator LED 140, but also conduct through the shortest path, so that the ESD may be conducted to the housing 110 through the flexible flat cable 120. Therefore, the electronic components and the circuit board 150 in the housing 110 may be impacted; further, the operation of the conventional optical disc drive 100 may fail.

Therefore, in order to prevent the internal electronic components from being impacted by the ESD, the ESD current is usually guided into the ground by shielding. For example, the shielding method can be achieved by the following: first, covering a plastic layer 170a upon the switch 130a and the indicator LED 140; then, covering a metal layer 170b, wherein the metal layer 170b is electrically connected with the housing 110. Therefore, when ESD occurs, the current may be connected to the ground through the metal layer 170b and the housing 110 in sequence. Although the ESD protection method can protect the switch 130a, the indicator LED 140 and the circuit board 150, the ESD protection method needs many parts and the assemble thereof is time-consuming.

### SUMMARY OF THE INVENTION

Accordingly, the present invention is directed to provide an optical disc drive with the capability of ESD protection.

According to the above and other aspects, the present invention provides an optical disc drive, including a housing, a fixing part, a flexible flat cable and an electronic component. Wherein, the fixing part is disposed in the housing. The flexible flat cable is disposed in the housing and includes a first and a second portions. The first portion has a component-disposed region whose backside is in contact with the fixing part. The second portion is connected and opposite to the first portion. The second portion has a conductive surface. Wherein, the component-disposed region is located between the fixing part and the conductive surface. The electronic component is disposed on the component-disposed region.

According to one embodiment of the present invention, the second portion further has an insulated surface, and the insulated surface is opposite to the component-disposed region. And, the insulated surface and the conductive surface are respectively the two opposite surfaces of the second portion.

According to one embodiment of the present invention, there is a distance between the conductive surface and the component-disposed region.

According to one embodiment of the present invention, the optical disc drive further includes a spacer column disposed between the second portion and the component-disposed region.

According to one embodiment of the present invention, the flexible flat cable further has a pivoting portion disposed between the second portion and the first portion, and the second portion covers at least a part of the first portion by pivoting along the pivoting portion.

According to one embodiment of the present invention, the second portion has an opening, and the electronic component is disposed in the opening.

According to one embodiment of the present invention, the first portion has a grounding hole, and the conductive surface is electrically connected with the grounding hole.

According to one embodiment of the present invention, the optical disc drive further includes a circuit board disposed in the housing, and the circuit board is electrically connected with the first portion of the flexible flat cable.

According to one embodiment of the present invention, the optical disc drive further includes an optical disc tray disposed in the housing. The component-disposed region of the flexible flat cable is disposed in one side surface of the optical disc tray, and the fixing part is disposed in the optical disc tray.

According to one embodiment of the present invention, the optical disc drive further includes a panel fixed in one side surface of the optical disc tray and covering the conductive surface.

According to the above, the optical disc drive of the present invention additionally adds a second portion in the original flexible flat cable, and the second portion can be folded, so that the conductive surface can cover the component-disposed region to achieve the capability of ESD protection. Therefore, it is more convenient to assemble the optical disc drive of the present invention.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective diagram of a conventional optical disc drive.

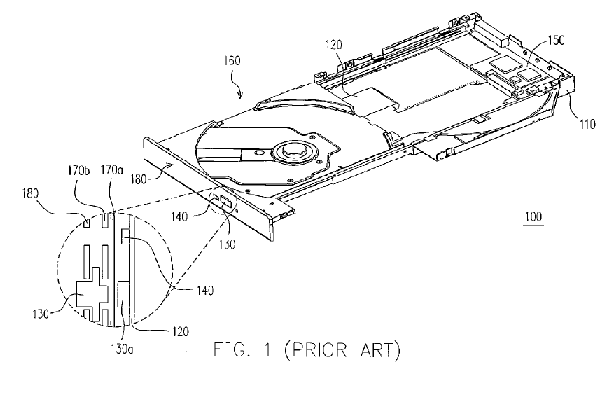

FIG. 2 is a perspective diagram of the optical disc drive according to one embodiment of the present invention.

FIG. 3 is a perspective diagram of the optical disc drive according to one embodiment of the present invention, wherein part of the housing, panel, and button are not shown.

FIG. 4 is a perspective diagram of the flexible flat cable in FIG. 3.

FIG. 5A is a partial expansion diagram of the flexible flat cable in FIG. 4.

FIG. 5B is a full expansion diagram of the flexible flat cable in FIG. 4.

### DESCRIPTION OF EMBODIMENTS

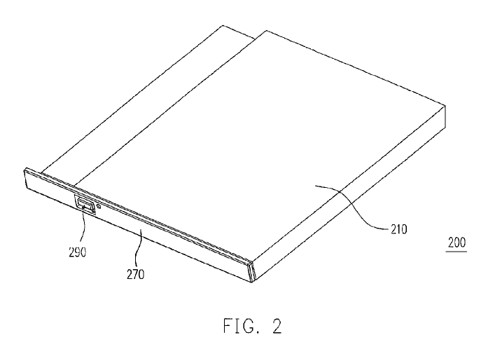

FIG. 2 is a perspective diagram of an optical disc drive according to one embodiment of the present invention. Referring to FIG. 2, the optical disc drive 200 according to the embodiment is, for example, an optical disc drive of a notebook computer. The optical disc drive 200 includes a housing 210, a panel 270, and a button 290, wherein the panel 270 and the button 290 are both disposed in one side surface of the housing 210. In general, a manufacturer may make different kind of identifiers in the panel 270, so the panel 270 and the button 290 are usually the final parts in the assembly of the optical disc drive 200. The following will describe the internal structure of the optical disc drive 200.

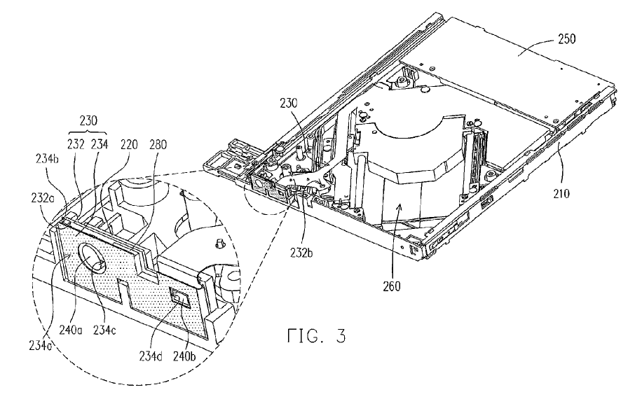

FIG. 3 is a perspective diagram of an optical disc drive according to one embodiment of the present invention, wherein part of the housing, panel, and button are not shown. Referring to FIG. 3, the optical disc drive 200 includes a fixing part 220, a flexible flat cable 230 and a first electronic component 240a. The fixing part 220 is disposed in the housing 210. Moreover, the flexible flat cable 230 is disposed in the housing 210 and includes a first portion 232 and a second portion 234. The second portion 234 is connected with and opposite to the first portion 232. In detail, the first portion 232 has a component-disposed region 232a whose backside is in contact with the fixing part 220, and the first electronic component 240a is disposed in the component-disposed region 232a. Moreover, the second portion 234 has a conductive surface 234a, and the conductive surface 234a may be the exposed copper region of the second portion 234. In brief, the component-disposed region 232a is disposed between the fixing part 220 and the conductive surface 234a. In addition, the panel 270 in FIG. 2 covers the conductive surface 234a.

In the embodiment, the first electronic component 240a is, for example, a switch, and the second portion 234 may have a first opening 234c to expose part of the first electronic component 240a. However, if the second portion 234 does not have the first opening 234c, the user can also activate the first electronic component 240a by pressing the second portion 234. Moreover, in the embodiment, the optical disc drive 200 may further include a second electronic component 240b disposed in the component-disposed region 232a. Also, the second portion 234 may also have a second opening 234d, and the second opening 234d exposes the second electronic component 240b. If the second electronic component 240b is an indicator LED, the light beam emitted from the second electronic component 240b can be transmitted to the outside through the second opening 234d.

In the embodiment, the optical disc drive 200 further includes a circuit board 250 and an optical disc tray 260, wherein the circuit board 250 is disposed in the housing 210 and connected with the first portion 232 of the flexible flat cable 230. The circuit board 250 is suitable for controlling the operation of other elements in the optical disc drive 200. Moreover, the optical disc tray 260 is disposed in the housing 210, and the component-disposed region 232a of the flexible flat cable 230 is disposed at one side surface of the optical disc tray 260, and the fixing part 220 is disposed on the optical disc tray 260.

When ESD occurs, the electrostatic can be grounded through the second portion 234, the flexible flat cable 230 and the circuit board 250. Therefore, compared with the conventional technologies, the flexible flat cable 230, the first electronic component 240a and other electronic components are unlikely to be damaged due to ESD. In other words, compared with the conventional technologies, the optical disc drive 200 of the preferred embodiment can pass the reliability test of the related ESD testing more easily.

Referring to FIG. 2 and FIG. 3, in order to reduce the possibility that the optical disc drive 200 is damaged by ESD, the first portion 232 of the flexible flat cable 230 may also have a grounding hole 232b, so that the ESD current can be guided to the ground through the second portion 234 and the grounding hole 232b. Moreover, in order to avoid the electrostatic from bouncing into the component-disposed region 232a, a distance between the conductive surface 234a and the component-disposed region 232a is usually maintained. The longer the distance is, the less the possibility of the electrostatic bounce is. Therefore, the optical disc drive 200 of the embodiment further includes a spacer column 280 disposed between the second portion 234 and the component-disposed region 232a.

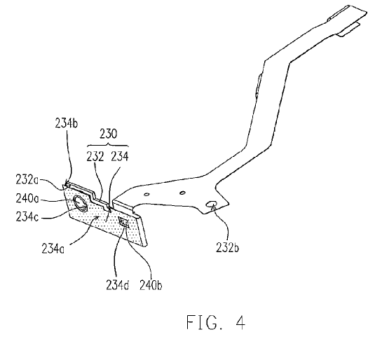

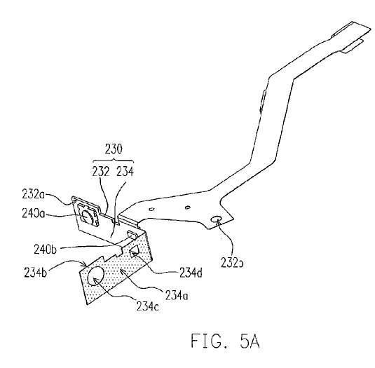

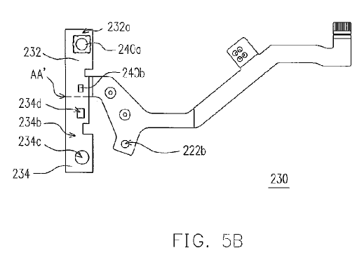

Referring to FIG. 4, FIG. 5A, and FIG. 5B, in order to reduce the possibility of the electrostatic bouncing, the second portion 234 may also have an insulated surface 234b, and the insulated surface 234b is opposite to the component-disposed region 232a. The insulated surface 234b and the conductive surface 234a are respectively the two opposite surfaces of the second portion 234. In other words, the insulated surface 234b is disposed in one surface of the second portion 234 which faces the component-disposed region 232a, and the conductive surface 234a is disposed in another surface of the second portion 234. In addition, the insulated surface 234b is the insulated surface of the flexible flat cable 230. The following will describe the assembly of the flexible flat cable 230.

FIG. 4 is a perspective diagram of the flexible flat cable in FIG. 3, and FIG. 5A is a partial expansion diagram of the flexible flat cable in FIG. 4. FIG. 5B is a full expansion diagram of the flexible flat cable in FIG. 4. Referring to FIG. 3, FIG. 4, FIG. 5A and FIG. 5B, first, the flexible flat cable 230 is assembled in the housing 210 as shown in FIG. 5A. Then, the pivoting portion AA′ of the flexible flat cable 230 is folded, so that the second portion 234 covers the component-disposed region 232a as shown in FIG. 5B. The pivoting portion AA′ is disposed between the second portion 234 and the first portion 232, so the second portion 234 can be folded along the pivoting portion AA′ to cover at least a part of the first portion 232. Till now, the assembly of the flexible flat cable 230 is substantially completed. Finally, the panel 270 and the button 290 are assembled on the side surface of the optical disc tray 260, so that the assembly of the optical disc drive 200 is completed. It needs to be noticed that, although the embodiment is described by the example of the optical disc drive of a notebook computer, the flexible flat cable 230 of the embodiment can also be applied in an optical disc drive of a desktop computer.

In summary, the preferred embodiment of the present invention additionally designs a second portion in the flexible flat cable, and the second portion is folded so that the conductive surface covers the component-disposed region, so as to provide the capability of ESD protection. Compared with the conventional technologies, it is easier to assemble the optical disc drive of the preferred embodiment of the present invention. In other words, compared with the conventional technologies, the preferred embodiment of the present invention can provide the capability of ESD protection by only changing the design of the flexible flat cable, and no additional electronic components are needed. Therefore, the fabricating cost of the optical disc drive with flexible flat cable can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical disc drive, comprising
a housing;
a fixing part, disposed in the housing;
a flexible flat cable, disposed in the housing, and the flexible flat cable comprising:
a first portion, having a component-disposed region whose backside is in contact with the fixing part;
a second portion, connected and opposite to the first portion, having a conductive surface, wherein the component-disposed region is located between the fixing part and the conductive surface; and
an electronic component, disposed on the component-disposed region.

2. The optical disc drive as claimed in claim 1, wherein the second portion further has an insulated surface, and the insulated surface is opposite to the component-disposed region, and the insulated surface and the conductive surface are respectively two opposite surfaces of the second portion.

3. The optical disc drive as claimed in claim 1, wherein there is a distance between the conductive surface and the component-disposed region.

4. The optical disc drive as claimed in claim 1 further comprises a spacer column disposed between the second portion and the component-disposed region.

5. The optical disc drive as claimed in claim 1, wherein the flexible flat cable has a pivoting portion disposed between the second portion and the first portion, and the second portion is folded along the pivoting portion so as to cover at least a part of the first portion.

6. The optical disc drive as claimed in claim 1, wherein the second portion has an opening, and the electronic component is disposed in the opening.

7. The optical disc drive as claimed in claim 1, wherein the first portion has a grounding hole, and the conductive surface is electrically connected with the grounding hole.

8. The optical disc drive as claimed in claim 1 further comprises a circuit board disposed in the housing, and the circuit board is electrically connected with the first portion of the flexible flat cable.

9. The optical disc drive as claimed in claim 1 further comprises an optical disc tray disposed in the housing, and the component-disposed region of the flexible flat cable is disposed in one side surface of the optical disc tray, and the fixing part is disposed in the optical disc tray.

10. The optical disc drive as claimed in claim 9 further comprises a panel fixed at one side surface of the optical disc tray and covering the conductive surface.
